(19) United States
(12) Patent Application Publication
(10) Pub. No.: US 2025/0265078 A1
(43) Pub. Date: Aug. 21, 2025

(54) DEPLOYING MULTIPLE VERSIONS OF SOFTWARE SIMULTANEOUSLY, WITH SCALING OF TRAFFIC BETWEEN VERSIONS

(71) Applicant: The PNC Financial Services Group, Inc., Pittsburgh, PA (US)

(72) Inventors: Michael Robert William Minella, Pittsburgh, PA (US); Connor Thompson, Pittsburgh, PA (US); Joshua Maciak, Pittsburgh, PA (US)

(21) Appl. No.: 18/442,780

(22) Filed: Feb. 15, 2024

(51) Int. Cl. G06F 8/71; G06F 8/60

(52) U.S. Cl. CPC G06F 8/71; G06F 8/60

(57) ABSTRACT

Computer-based systems and methods control network traffic allocation to different versions of a software application for a service. A first version of the software application runs on a first network resource and a second, different version of the software application runs on a second network resource. A load balancer is in communication with the first and second network resources. A toggle interface receives user input indicative of a desired network traffic allocation between the first and second versions of the software application. A version control service is for: periodically polling the toggle interface for an updated network traffic allocation between the first and second versions of the software application, where the updated network traffic allocation is based on the user input received by the toggle interface; and communicating the updated network traffic allocation between the first and second versions of the software application to the load balancer. The load balancer is for allocating network traffic for the software application to the first and second versions of the software application in accordance with the updated network traffic allocation.

### BACKGROUND

Containerized applications are applications that run in isolated runtime environments called containers. Containers encapsulate an application with all its dependencies, including system libraries, binaries, and configuration files. This all-in-one packaging makes a containerized application portable by enabling it to behave consistently across different hosts, allowing developers to write once and run almost anywhere. Containers, however, do not include their own operating systems (OS). Different containerized applications running on a host system, instead, share the existing OS provided by that system. Without any need to bundle an extra OS along with the application, containers are extremely lightweight and can launch very fast. To scale an application, more instances of a container can be added almost instantaneously.

### SUMMARY

In one general aspect, the present invention is directed to computer-based systems and methods for controlling network traffic allocation to different versions of a software application for a service. The software application can be a containerized application, for example, running in a container of an enterprise network. The second version can be a newer version of the first version, such as fixing a bug(s) in the first version. For example, the second version can be designed to replace the first version. The allocation between the first and second version can be changed over time, such as by a user, as the performance and operation of the second version is validated. That way, the traffic to the second version can be increased over time with the second version eventually replacing the first version, and with a non-immediate (e.g., eventual or gradual) deployment of traffic from the first and second versions, as stability and reliability of the second version are tested with less than all network traffic, and with the first version being correspondingly phased out, such that, as confidence grows in the second version, it completely replaces the first version. The first and second versions can be containerized applications on different pods. Prior to the first version being phased out completely, the two versions are operated simultaneously with varying and controllable degrees of network traffic. The network traffic can be, for example, HTTP requests for the service provided by the service.

As such, a computer-based system according to various embodiments of the present invention can comprise a first version of the software application running on a first network resource of the computer-based system; a second (different) version of the software application running on a second network resource of the computer-based system; and a load balancer in communication with the first and second network resources. The computer-based system can also comprise a toggle interface for receiving user input indicative of a desired network traffic allocation between the first and second versions of the software application. The computer-based system can further comprise a version control service for: periodically polling the toggle interface for an updated network traffic allocation between the first and second versions of the software application, where the updated network traffic allocation is based on the user input received by the toggle interface; and communicating the updated network traffic allocation between the first and second versions of the software application to the load balancer. The load balancer then allocates network traffic for the software application to the first and second versions of the software application in accordance with the updated network traffic allocation.

These and other benefits that can be realized through embodiments of the present invention are apparent from the description that follows.

### FIGURES

Various embodiments of the present invention are described herein by way of example in conjunction with the following figures.

FIG. 1 is a schematic representation of an exemplary computer-implemented digital experience application comprising a plurality of micro-applications, according to various embodiments of the present invention;

FIG. 2 is a schematic representation of an exemplary driver application hosting a collection of micro-applications according to various embodiments of the present invention;

FIG. 3 is a schematic representation of an exemplary digital experience application according to various embodiments of the present invention.

FIG. 4 is a schematic representation of an exemplary computer-implemented event hub for routing event information of a digital experience application, according to various embodiments of the present invention.

FIG. 5 is a schematic representation of a computer system, according to various embodiments of the present invention, for dynamically and simultaneously allocating network traffic to two different versions of a service.

FIG. 6 is a diagram of a user interface provided by the toggle interface according to various embodiments of the present invention.

### DESCRIPTION

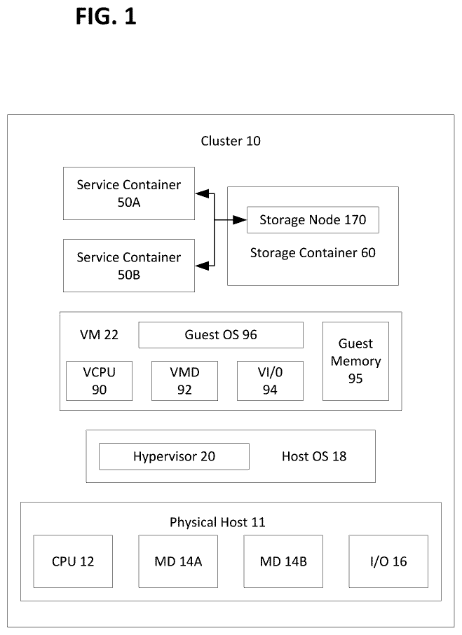

Various embodiments of the present invention are directed to systems and methods for dynamically and simultaneously allocating network traffic between two versions of a software application for a service, particularly where the second version is to replace the first version, so that the second version can be tested in a deployment setting without having the second version immediately handling all of the network traffic for the service. Embodiments of the present invention can be deployed, for example, with micro-applications running in containerized environments. Accordingly, at the outset, with reference to FIGS. 1 through 4, general details about containerized applications and micro-applications are provided. Then aspects of the novel version allocation systems and methods of the present invention are described.

FIG. 1 is a block diagram of a computer cluster 10, such as OpenShift Dedicated cluster, according to various embodiments of the present invention. The cluster 10, which may be implemented in a cloud-computing environment, may include one or more physical hosts, including physical host 11. Physical host 11 may in turn include one or more physical processor(s) (e.g., CPU) 12 communicatively coupled to one or more memory device(s) 14A-B and one or more input/output device(s) (e.g., I/O) 16. The processor(s) 12 is an electronic device capable of executing instructions encoding arithmetic, logical, and/or I/O operations. The processor(s) 12 may include an arithmetic logic unit (ALU), a control unit, and a plurality of registers. In an example, the processor(s) 12 may be a single core processor which is typically capable of executing one instruction at a time (or process a single pipeline of instructions), or a multi-core processor which may simultaneously execute multiple instructions and/or threads. In another example, the processor(s) 12 may be implemented as a single integrated circuit, two or more integrated circuits, or may be a component of a multi-chip module (e.g., in which individual microprocessor dies are included in a single integrated circuit package and hence share a single socket). The processor(s) 12 may also be referred to as a central processing unit (“CPU”).

The memory devices 14A-B may be volatile or non-volatile memory devices, such as RAM, ROM, EEPROM, or any other device capable of storing data. The memory devices 14A may be persistent storage devices such as hard drive disks (“HDD”), solid-state drives (“SSD”), and/or persistent memory (e.g., Non-Volatile Dual In-line Memory Module (“NVDIMM”)). I/O device(s) 116 refers to devices capable of providing an interface between one or more processor pins and an external device, the operation of which is based on the processor inputting and/or outputting binary data. CPU(s) 12 may be interconnected using a variety of techniques, ranging from a point-to-point processor interconnect, to a system area network, such as an Ethernet-based network. Local connections within physical hosts 11, including the connections between processor(s) 12 and memory devices 14A-B and between processor(s) 12 and I/O device 16 may be provided by one or more local buses of suitable architecture, for example, peripheral component interconnect (PCI).

The physical host 11 may run one or more isolated guests, for example, a VM 22, which may in turn host additional virtual environments (e.g., VMs and/or containers). In an example, a container (e.g., storage container 60, service containers 50A-B) may be an isolated guest using any form of operating system level virtualization, for example, Red Hat® OpenShift®, Docker® containers, chroot, Linux®-VServer, FreeBSD® Jails, HP-UX® Containers (SRP), VMware ThinApp®, etc. Storage container 60 and/or service containers 50A-B may run directly on a host operating system (e.g., host OS 18) or run within another layer of virtualization, for example, in a virtual machine (e.g., VM 22). In an example, containers that perform a unified function may be grouped together in a container cluster that may be deployed together, e.g., in a Kubernetes® pod. A pod is a group of one or more containers, with shared storage and network resources, and a specification of how to run the containers. A pod's contents can be co-located and co-schedule, and run in a shared context.

The cluster 10 may run one or more VMs (e.g., VMs 22), by executing a software layer (e.g., hypervisor 20) above the hardware and below the VM 22. The hypervisor 20 may be a component of respective host operating system 18 executed on physical host 11, for example, implemented as a kernel based virtual machine function of host operating system 18. In another example, the hypervisor 20 may be provided by an application running on host operating system 18. The hypervisor 20 may also run directly on physical host 11 without an operating system beneath hypervisor 20. Hypervisor 20 may virtualize the physical layer, including processors, memory, and I/O devices, and present this virtualization to VM 22 as devices, including virtual central processing unit (“VCPU”) 90, virtual memory devices (“VMD”) 92, virtual input/output (“VI/O”) device 94, and/or guest memory 95. In an example, another virtual guest (e.g., a VM or container) may execute directly on host OSs 18 without an intervening layer of virtualization.

The VM 22 may be a virtual machine and may execute a guest operating system 96, which may utilize the underlying VCPU 90A, VMD 92A, and VI/O 94A. Processor virtualization may be implemented by the hypervisor 20 scheduling time slots on physical CPUs 12 such that from the guest operating system's perspective those time slots are scheduled on a virtual processor 90. The VM 22 may run on any type of dependent, independent, compatible, and/or incompatible applications on the underlying hardware and host operating system 18. The hypervisor 20 may manage memory for the host operating system 18 as well as memory allocated to the VM 22 and guest operating system 96 such as guest memory 95 provided to guest OS 96. In an example, storage container 60 and/or service containers 50A, 50B are similarly implemented.

In addition to distributed storage provided by storage container 60, a storage controller may additionally manage storage in dedicated storage nodes (e.g., NAS, SAN, etc.). In an example, a storage controller may deploy storage in large logical units with preconfigured performance characteristics (e.g., storage nodes 70). In an example, access to a given storage node (e.g., storage node 70) may be controlled on an account and/or tenant level. In an example, a service container (e.g., service containers 50A-B) may require persistent storage for application data, and may request persistent storage with a persistent storage claim to an orchestrator of the cluster 10. In the example, a storage controller may allocate storage to service containers 50A-B through a storage node (e.g., storage nodes 70) in the form of a persistent storage volume. In an example, a persistent storage volume for service containers 50A-B may be allocated a portion of the storage capacity and throughput capacity of a given storage node (e.g., storage nodes 70). In various examples, the storage container 60 and/or service containers 50A-B may deploy compute resources (e.g., storage, cache, etc.) that are part of a compute service that is distributed across multiple clusters (not shown in FIG. 1).

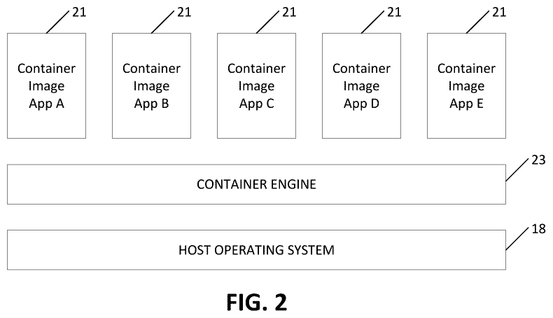

FIG. 2 is a diagram of an illustrative container architecture, such as for one of the service containers 50A-B. A container is a standard unit of software that packages up code and all its dependencies so that the application runs quickly and reliably from one computing environment to another. When a container is not running, however, it exists only as a saved file called a container image 21. Each container image 21 is a package of the application source code, binaries, files, and other dependencies that will live in the running container. When a containerized application starts, the contents of its container image 21 are copied before they are spun up in a container instance. Each container image 21 can be used to instantiate any number of containers. In addition, container images can be shared with others via a public or private container registry. To promote sharing and maximize compatibility among different platforms and tools, container images are typically created in the industry-standard Open Container Initiative (OCI) format.

A container engine 21 is a lightweight, standalone, executable package of software that includes everything needed to run an application: code, runtime, system tools, system libraries and settings. The container engine 23 enables the host OS 18 to act as a container host. The container engine 23 accepts user commands to build, start, and manage containers through client tools (including CLI-based or graphical tools), and it provides an API that enables external programs to make similar requests. The container engine 23 can comprise a container runtime, which is responsible for creating the standardized platform on which applications can run, for running containers, and for handling the container's storage needs on the local system.

Docker is a set of platform-as-a-service products that use OS-level virtualization to deliver software in containers. OpenShift from Red Hat is a Docker-based, layered system that abstracts the creation of Linux-based container images. Cluster management and orchestration of containers on multiple hosts is handled by Kubernetes.

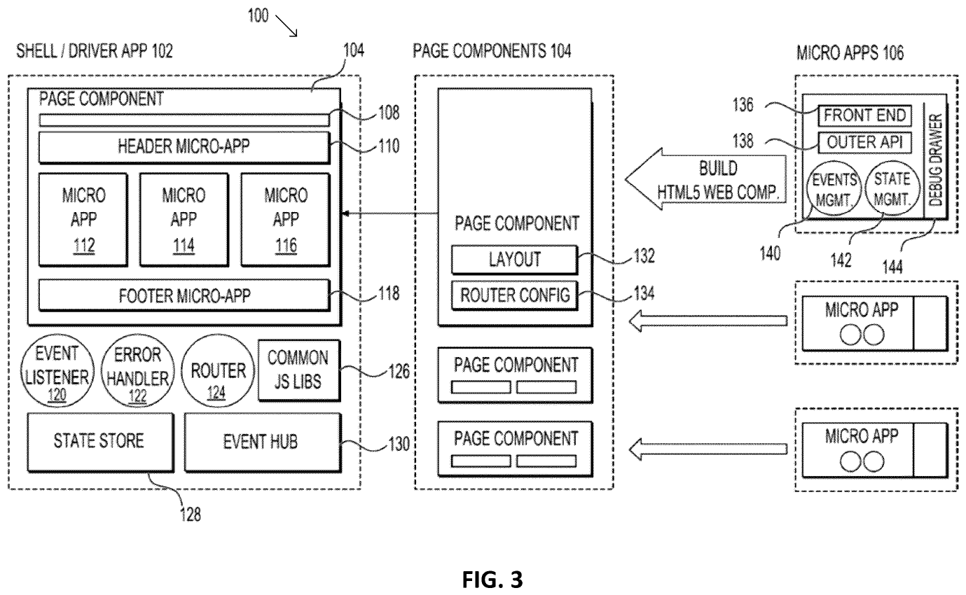

FIG. 3 is a schematic representation of an exemplary computer-implemented digital experience application 100. In accordance with disclosed embodiments, digital experience application 100 may comprise a plurality of micro-applications 106 configured to detect events relating to the application 100 (i.e., application events) and states relating to the application 100 (i.e., application states). The digital experience application 100 may include one or more driver applications 102 for hosting and managing the plurality of micro-applications 106. A driver application 102, also referred to as a “channel application,” can include one or more page components 104 configured to lay out and route information to and from the plurality of micro-applications 106. The driver application 102 may also include one or more event hubs 130 configured to receive the detected application events from the plurality of micro-applications 106 and route the detected application events to the plurality of micro-applications 106 and/or other components of application 100. Driver application 102 may also include one or more state stores 128 configured to store the detected application states received from the plurality of micro-applications.

In some embodiment, the digital experience application 100 may comprise one or more event listeners 120 configured to respond when an event occurs in the plurality of micro-applications 106; one or more error handlers 122 configured to respond to error conditions in the plurality of micro-applications 106; one or more routers 124 configured to forward information received from the plurality of micro-applications 106; and one or more common libraries 126 comprising resources and/or functions used by the plurality of micro-applications 106. In various embodiments, the driver application 102 can be configured to provide information to the page component 104 for ensuring that the plurality of micro-applications 106 function and are displayed in a similar manner. For example, the driver application 102 can provide, to the page component 104, information corresponding to a common style scheme, which may include information relating to font styles, font size, buttons, links, and the like. In some embodiments, the information may relate to features for backwards compatibility, for example to provide backwards compatibility with older web browsers for displaying the application 100. This may include polyfill code or the like to allow developers to use an interface or feature of application 100 whether it is supported by a browser or not.

A page component 104 may include router configuration information 134 so that page component 104 may be configured to represent or act as a route in the driver application 102 and host a micro-application 106 corresponding to that route. For example, if a user interacts with a micro-application 106, the page component 104 may be configured to send data corresponding to that user interaction to the driver application 102. As another example, a user may interact with a micro-application on a first page component, which may act as a route to send data corresponding to that user interaction to a second page component (enabling page routing). A page component 104 may include layout 132 providing information configured to specify the layout of the micro-application 106. To illustrate using FIG. 3 as an example, layout 132 may include information such that page component 104 may be configured to position a first micro-application 106 at the top of the page component 104, corresponding to a navigation bar micro-application 108 in this example; position a second micro-application, corresponding to a header micro-application 110 in this example, below the first micro-application 108; position a third micro-application, corresponding to a footer micro-application 118 in this example, at the bottom of the page component 104; and position fourth, fifth, and sixth micro-applications (112, 114, 116) between the header micro-application 110 and footer micro-application 118.

In some embodiments, the driver application 102 aggregates a plurality of micro-applications 106 to develop the user experience of the application 100. This framework enables application developers to build applications, such as application 100, using small, discrete pieces (i.e., the micro-applications). In some embodiments, the driver application 102 comprises a Single Page Application (SPA), which may be developed, for example, using the Angular platform. A micro-application 106 can be configured to perform one or more discrete functions, for example using functional logic. The micro-application 106 may represent an independent vertical slice of the business functionality provided by the application 100. The micro-application 106 can comprise a front-end 136, (i.e. a user interface, such as a graphical user interface or “GUI”) configured to interface with a user by receiving input information from the user and/or providing information to the user. For example, a micro-application 106 may contain a front-end 136 for receiving user input in the form of a mouse-click on a browser, interaction with a button, touch screen, touch panel, keyboard input, or the like. Front end 136 may also provide information to the user through a display or the like. The front-end 136 of the micro-application 106 may be created using a front-end web platform for building mobile and desktop web applications, such as the Angular platform. In some embodiments, as shown in FIG. 3, micro-application 106 may be loaded onto the page component 104 and to the driver application 102 using a web platform such as HTML5 web component technology or the like.

In some embodiments, the micro-application 106 may comprise an outer interface 138 (also referred to as a back end) corresponding to the front end 136 of the micro-application 106. The outer interface 138 may be configured for receiving information from and sending information to a component or source outside the driver application 102. For example, the outer interface 138 may be configured for receiving information from a database. In some embodiments, the outer interface 138 may be an application programming interface (API). The outer interface 138 may route information to and from an Inner API, as disclosed in Provisional U.S. Patent Application Ser. No. 62/983,535, the contents of which are incorporated herein. The micro-application 106 may contain an outer interface 138 developed using spring boot or Bootstrap framework. In some embodiments, the front-end 136 and the outer interface 138 of a micro-application 106 may be deployed as a separate container, such as a docker container, in a container application, such as OpenShift Container Platform (OCP), or the like. This enables the micro-application 106 to run quickly and reliably from one computing environment to another.

In some embodiments, the micro-application 106 can further comprise an event manager 140 configured to send and receive event information. For example, event manager 140 may be configured to detect an application event belonging to a category and transmitting the detected application event. The detected application event may be transmitted to event hub 130, for example. The micro-application 106 can further comprise a state manager 142 configured to send and receive state information. For example, state manager 142 may be configured to detect an application state belonging to a category and transmitting the detected application state. The detected application event may be transmitted to state store 128, for example, for storage. In some embodiments, the micro-application can further comprise a debug drawer 144 configured to capture and replay events as a part of the micro-application communication.

In some embodiments, a micro-application 106 may not include an outer interface 138. Here, a micro-application 106 without an outer interface 138 may be configured to listen for events and state changes from other micro-applications. For example, a first micro-application may send event information to event hub 130 and state information to state store 128. A second micro-application configured to listen for events and state changes from first micro-application, or alternatively, the events and state changes belonging to a specific category, may then receive the event information from event hub 130 and state information from state store 128.

Event hub 130 can be configured to route event information to and from the plurality of micro-applications 106 and/or the driver application 102. The plurality of micro-applications 106 and/or the driver application 102 can be configured to transmit or receive event information to and/or from the event hub 130 as a result of or in response to a user input or other user interaction with micro-applications 106. Alternatively or additionally, the plurality of micro-applications 106 and/or the driver application 102 may be configured to transmit or receive event information to and/or from the event hub 130 as a background process. Accordingly, micro-applications 106 and/or the driver application 102 may publish events in response to either a user interaction or a background process. In some embodiments, event hub 130 may be integrated into the driver application 102. The event hub 130 may be configured to route information based on one or more criteria. For example, the event hub 130 may be configured to route event information from a first source to a first set of micro-applications, and it may be configured to route event information from a second source to a second set of micro-applications. The event hub 130 may route or filter the event information from the first and second sources using a source identification value emitted by the source.

In some embodiments, micro-applications 106 and/or driver application 102 may “subscribe” to receiving event information. For example, micro-applications 106 and/or driver application 102 may be subscribed to receiving event information from a specific source. In this case, the event hub 130 may be configured to route event information only to micro-applications 106 or driver application 102 subscribed to receiving information from the specific source before the event occurs. In some embodiments, a micro-application 106 or driver application 102 may be late in subscribing to receive the event information from the source before the event occurs. In this case, the micro-application 106 or driver application 102 that subscribes late does not receive the event information. In some embodiments, the event hub 130 may be configured to route “special” event information differently, such as for navigating the driver application 102 to a different page, as described in further detail below. In some embodiments, the event hub 130 can be configured to be a singleton, such that only a single instance of the event information is relayed. In this manner, the system can ensure that only correct and up-to-date event information is transmitted.

In some embodiments, state store 128 may be integrated into the driver application 102. State store 128 can be configured to store state information relating to application 100. The state store 128 may comprise a database, server, local storage, or the like. For example, state store 128 may comprise in-browser memory, with state information being stored as an object, such as a JavaScript Object Notation (JSON) object. The state store 128 can be further configured to route state information to and/or from the plurality of micro-applications 106 and/or the driver application 102. The plurality of micro-applications 106 and/or the driver application 102 can be configured to transmit or receive state information to and/or from the state store 128 as a result of or in response to a user input or other user interaction with micro-applications 106. Alternatively or additionally, the plurality of micro-applications 106 and/or the driver application 102 may be configured to transmit or receive state information to and/or from the state store 128 as a background process. Accordingly, micro-applications 106 and/or driver application 102 may update the application state of application 100.

In some embodiments, similar to the event hub 130 described above, state store 128 can be further configured to route state information based on one or more criteria. For example, the state store 128 may be configured to route state information from a first source to a first set of micro-applications, and may route state information from a second source to a second set of micro-applications. The state store 128 may route the state information from the first and second sources using a source identification value emitted by the source. In some embodiments, micro-applications 106 and/or driver application 102 may “subscribe” to receiving state information. For example, micro-applications 106 and/or driver application 102 may be subscribed to receiving state information from a specific source. In this case, the state store 128 may be configured to send state information only to micro-applications 106 or driver application 102 subscribed to receiving state information from the specific source before the state changes. In some embodiments, a micro-application 106 or driver application 102 may be late in subscribing to receive the state information from the source. In this case, the micro-application 106 or driver application 102 that subscribes late does not receive the state information. In some embodiments, the state store 128 can be configured to be a singleton, such that only a single instance of the state information is relayed. In this manner, the system can ensure that only correct and up-to-date state information is transmitted, as the state store 128 acts as the single source of truth. In various embodiments, the state store 128 can be configured to automatically transmit state information to new micro-applications 106 that are added to the driver application 102 and/or the digital experience application 100.

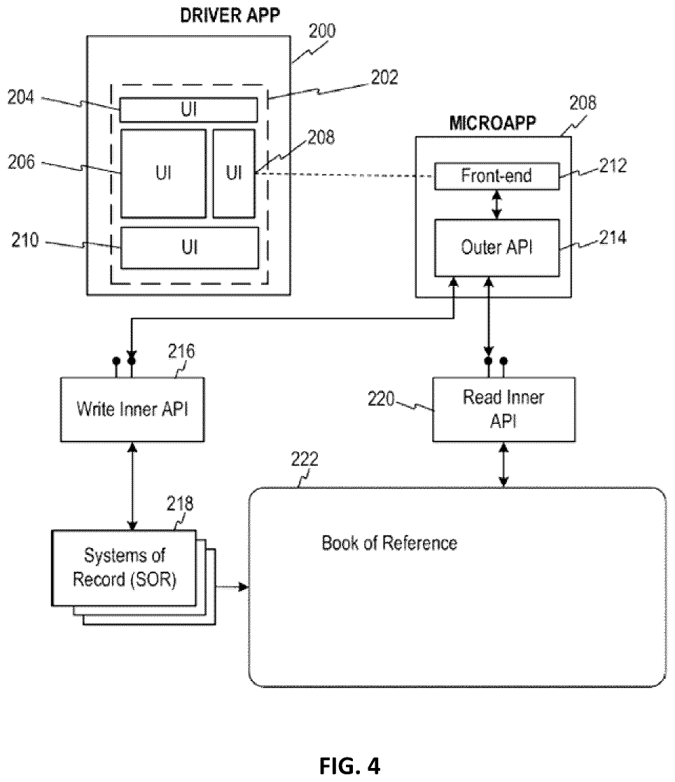

FIG. 4 is a schematic representation of an exemplary driver application hosting a collection of micro-applications according to embodiments of the present disclosure. The driver application may be a Single Page Application (SPA) 200, which may be developed, for example, using the Angular platform. SPA may be configured to load a single HTML page and dynamically update that page as the user interacts with the application. SPA 200 includes a page component 202 and hosts micro-applications 204, 206, 208, and 210 to create the user experience of the SPA 200. Micro-application 208 may include a front end 212 configured to interface with a user by receiving input information from the user and/or providing information to the user. Micro-application 208 may further include an outer interface 214 such as an API. Outer API 214 may be configured to interact with components outside of SPA 200, such as a Systems of Record (SOR) 218 via Write Inner API 216, and/or interact with a Book of Reference 222 via Read Inner API 220.

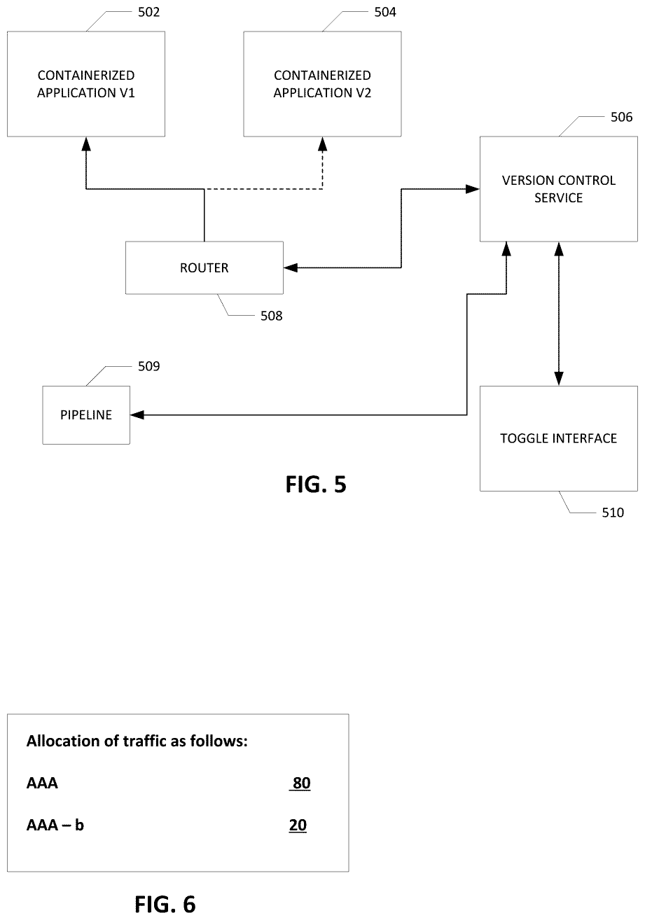

Having now described micro-applications, aspects of the present invention with respect to how a software developer (or software development team) can deploy a second version of a software application (sometimes referred to herein as the “green” version), such as a containerized application, with the second version eventually replacing an original (or first or “blue”) version, and with a non-immediate (e.g., eventual or gradual) deployment of traffic from the first/blue version to the second/green version, as stability and reliability of the second version are tested with less than all traffic, and with the first/blue version being correspondingly phased out, such that, as confidence grows in the second/green version, it completely replaces the first/blue version, are described in connection with FIG. 5. In FIG. 5, the first/blue version is application 502 and the second/green version is application 504. These versions 502, 504 may be, in various embodiments, containerized applications on different pods for example. Prior to the first/blue version 502 being phased out, the two versions are operated simultaneously with varying and controllable degrees of network traffic. The network traffic can be, for example, HTTP requests for the service provided by application 502/504 that are sent to the application 502/504 via an electronic data network, e.g., a LAN or WAN of the enterprise, and/or the Internet.

Also, the first/blue and second/green versions are preferably non-identical; otherwise there would be no need to replace the first version for the second version. As such, both the first/blue and second/green versions 502, 504 can perform the same general function for the enterprise that deploys them, but the second/green version 504 preferably includes enhancements, revisions, bug fixes, etc., relative to the first/blue version 502, such that it is desirous for the enterprise to eventually replace the first/blue version 502 with the second/green version 504. It can be risky, from an enterprise operations standpoint, for the second/green version 504 to replace fully, immediately, and abruptly the first/blue version 502 because, as mentioned above, the stability, reliability, performance, etc. of the second/green version 504 may not have been fully validated in the environment in which it is to be deployed (e.g., a containerized environment). Thus, the simultaneous deployment of the two versions, with gradual, controlled traffic scaling from the first/blue application 502 to second/green application 504, can be implemented, as described herein.

Once the second version 504 fully replaces the first version 502, then the second version 504 can be replaced at some time later by a third version of the application in a similar manner, and so on as new versions of the application are developed and ready for deployment. Again, the second and third versions can perform the same general function for the enterprise, but the third version (not shown) may not be identical to the second version 504 because the third version includes enhancements, revisions, bug fixes, etc., relative to the second version 504, and so on.

FIG. 5 also depicts a version controller service 506, a router 508, a pipeline 509 and a toggle interface 510. The toggle interface 510 can be implemented as a user interface that allows the developer to specify (or “toggle”) the traffic split between the first and second versions 502, 504. In various embodiments, the toggle interface 510 implements/executes software to allow a user (e.g., a developer) to create, target and manage feature flags for software, particularly in this case, the first and second applications 502, 504. In various embodiments, the toggle interface 510 can be implemented with feature flag software from Split Software. The toggle interface 510 can provide a web interface that allows the user/developer to specify that traffic split between the first/blue and second/green versions 502, 504. In that connection, the toggle interface 510 can provide a web-based dashboard through which the user/developer can specify the traffic split. The software for the toggle interface 510 can be run on a server of the enterprise's network and may include a web server for providing the web-based dashboard to the user/developer. After the second/green application 504 is verified to be working on its pod, for example, the dynamic configuration for the second application 504 can be specified by the user via the toggle interface 510.

The deployment scheme allows two versions 502, 504 of the service to co-exist. Distinguishing between these two versions can achieved, for example, through a Boolean attribute (i.e., an attribute that can have one of two values), called “alternateDeploymentSlot” in this example (recognizing that other names can be used in other configurations), within their corresponding dynamic configuration in the associated toggle interface feature flag. In various embodiments, when the Boolean attribute (e.g., alternateDeploymentSlot) is set to false in the dynamic configuration, it signifies the version (e.g., first/blue version 502) that adheres to the standard naming conventions for deployment information, aligned with the regular single-pod deployment process. Conversely, when the Boolean attribute is set to true, it designates the alternative deployment version (e.g., second/green version 504). In this variant, the project name used for generating deployment information can be modified by appending, for example, the suffix “-b” or some other indicator, to the original project name. Consequently, in such an embodiment, the resulting deployment name and service name can also have this suffix, enabling the deployment of distinct versions.

To deploy the new green version 504 of the service using this deployment scheme, in various embodiments, users are required to access the toggle interface 510 and modify the traffic allocation between the versions. By designating the first/blue (stable) version 502 to have 100% of the traffic, the second/green version 504 is automatically selected to be overridden during the subsequent deployment process. Within the evaluation stage, a GET request (e.g., a HTTP request for data from a specified resource) can be sent to the version controller service 506 for the pod to obtain information about the service that has 0 traffic allocation according to the toggle interface 510. This information (e.g., the setting for alternateDeploymentSlot) can then be forwarded to the pipeline 509 for the deployment of the second/green version 504 of the service.

The pipeline 509 can be, for example, a server-based system that runs in servlet containers such as Apache Tomcat. The pipeline 509 can be an open source automation server that helps automate the parts of software development related to building, testing, and deploying, facilitating continuous integration, and continuous delivery. In various embodiments, a Jenkins pipeline can be used. The version controller service 506 can be, for example, a Kubernetes service running over a set of pods (with each pod being a collection of one or more containers and implemented with a set of computers and/or servers). As described herein, the version controller service 506 can periodically poll the toggle interface 510 for the current allocation of traffic between the first and second versions 502, and then correspondingly update the router 508, via an API between the version control service 506 and the router 508, with the updated allocation between the versions. The router 508 can be implemented with, for example, OpenShift's “Route” object or Kubernetes “Ingress” object. The router 508 can implemented with a HAProxy load balancer, for example.

In various embodiments, when the users are deploying for their very first instance of both the first and second versions of the service, the users do not need to make any traffic allocation changes in the toggle interface 510 for deploying the new version 504 of the service. In these situations, before having two services available in, for example, an OpenShift or other containerized environment, there is insufficient information present in the toggle interface 510 to necessitate any traffic adjustments.

However, in various embodiments, when the users are deploying for their very first instance of the first and second versions of the service, the users do not need to make any traffic allocation changes in the toggle interface 510 for deploying the new version 504 of the service. Considering the scenario when there is no sufficient information in the toggle interface 510 (before having two services to be switched), the version control service 506 can handle the retrieval process differently.

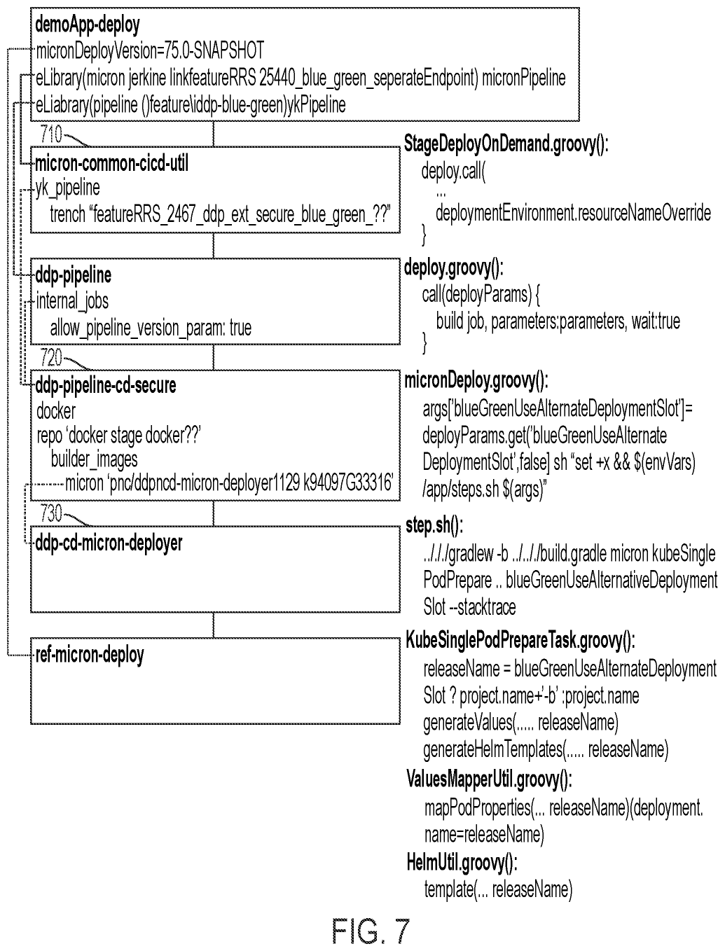

When deploying the very first version of the service, both dynamic configurations on the feature flag at the toggle interface 510 are empty. Similarly, when deploying the second version 504 of the service, one of the two dynamic configurations on the Feature flag is empty. Based on the number of empty dynamic configurations, the count of deployment versions controlled by the toggle interface 510 can be ascertained. Upon the initial deployment, where both dynamic configurations are empty, the version control service 506 can return {“alternateDeploymentSlot”: false} to the pipeline 509 when the GET request is sent to determine which version to be overridden. With the Boolean attribute alternateDeploymentSlot being set to false, the deployment can proceed following a standard naming convention for a regular single-pod deployment. Following the successful deployment of the first version 502, in a scenario where only one dynamic configuration in the feature flag remains empty, the version control service 506 can return an {“alternateDeploymentSlot”: true} to the pipeline 509 when the GET request is sent to determine which version to be overridden. Upon receiving the alternateDeploymentSlot being true, the pipeline 509 can append, for example, “-b” to the original project name. For instance, if the project name is “AAA,” as shown in the example of FIG. 6, the adjusted (green) project name becomes “AAA-b.” With this adjusted naming, the pipeline 509 proceeds to deploy the new/green version 504 of the service using the modified project name. These mechanisms ensure a smooth deployment process even when there is limited information available in the toggle interface 510, allowing for efficient utilization of two versions.

In various embodiments, the version control service 506 can perform the task of updating the deployment information on the toggle interface 510 upon receiving a POST request (e.g., a HTTP request to send data to a server to create or update a resource) from the pipeline 509. The update can be made, in various embodiments, to the dynamic configuration, manifested as a map encompassing certain key-value pairs, such as, for example:
alternateDeploymentSlot—a Boolean to differentiate the two deployment slots (described above).
deploymentVersion—a stringified integer that serves as an indicator of which one of the two services is the newer service.
releaseName—the name used in the deployment; can be used to generate a template (such as a Helm template, where Helm is an open source package manager that automates the deployment of software for Kubernetes).
deploymentName—release name with, for example, a “dep-” prefix.
serviceName—release name with, for example, a “svc-” prefix.
versions—a map of component names within the single pod and their corresponding tags.
routeNames—a list of routes associated with this specific service on OpenShift, for example.

When the POST request is made, the request body can include deployment information derived from the “DEPLOY_ON_DEMAND” stage. This information can encompass, for example, “releaseName,” “deploymentName,” “serviceName,” “versions,” and “routeNames.” Subsequently, the dynamic configuration can be correspondingly updated to reflect these changes. Notably, the “deploymentVersion” can be incremented during this update process. However, the deployment slot indicator, denoted as “alternateDeploymentSlot,” preferably remains unaltered over time, retaining its original value.

In various embodiments, the version control service 506 can employ a job scheduler that triggers periodically (e.g., every 3 seconds) after the second application 504 is up and running. In the context of adaptive deployment, all related feature flags can defined within, for example, a REF-RND-INFRA environment. To facilitate the synchronization process, the retrieval of all available feature flags with their corresponding split definitions from the REF-RND-INFRA environment can be performed. Subsequently, an iteration can be conducted over each feature flag to obtain the traffic allocation associated with it. Following this, the relevant routes specified in the “routeNames” field within their dynamic configuration are updated in, for example, the OpenShift route YAML using, for example, JSON Patch (a format for describing changes to a JSON document).

In various embodiments, there are three scenarios in which a synchronization task will not be performed: (1) if a feature flag is marked as “killed,” indicating it is no longer active; (2) if any of the dynamic configurations within a feature flag are empty, signifying that there are less than two services available for switching; and (3) if there are no changes made to the traffic allocation on the toggle interface. By considering these scenarios, the version control service 506 can effectively manage the synchronization between the toggle interface 510 and OpenShift, ensuring that accurate and up-to-date traffic allocation and routing configurations are maintained.

The toggle interface 510 may provide, for example, as shown in FIG. 6, a web-based interface where the user can specify, numerically, the percentage of traffic that each application 502, 504 is to receive. That is, with reference to FIG. 6, the user could specify via the interface a percentage of the traffic to be allocated to each version. The first application 502 (e.g. “AAA”) will receive percentage of traffic specified for it (80% in the example of FIG. 6) once the split is implemented and the second application 504 (e.g., AAA-b) will receive the remaining percentage (20% in this example). The toggle interface 510 can enforce a constraint that the percentage sum to 100, so that all of the network traffic for the service is routed to one of the applications 502, 504.

The following provides, with reference to FIG. 7, example code that can be used to integrate the toggle interface 510 into the pipeline 509 to facilitate the blue-green version deployment using plug-ins of a Jenkins pipeline according to various, non-limiting embodiments. micron-common-cicd-util 710 can contain plugins responsible for the stages in the pipeline. To enable blue-green deployment, two new stages can be added, called BLUE_GREEN_EVALUATION and UPDATE_FEATURE_FLAG to the pipeline. BLUE_GREEN_EVALUATION stage retrieves the deployment slot that will be used in the DeployOnDemand stage. In the BLUE_GREEN_EVALUATION stage, a GET request is sent to the version control service 506, which then returns the “alternateDeploymentSlot” to modify the release name for the subsequent deployment process. This deployment slot indicator is stored in the deployment environment as “blueGreenUseAlternateDeploymentSlot”. In the DeployOnDemand stage, the deploy method can be invoked from the ddp-pipeline repository. This method accepts the parameters provided, including the “blueGreenUseAlternateDeploymentSlot”. Also, an attribute, blueGreenUseAlternateDeploymentSlot, can be added to facilitate the blue-green deployment:

```
package com.xyz.ref.cicd
class DeployEnvironment implements Serializable {
  // . . . please refer to the repo for the complete code . . .
  // For blue green deployment to indicate the version that is going to
overridden. false:make no changes;
true:alter release name in downstream
KubeSinglePodPrepare
  Boolean blueGreenUseAlternateDeploymentSlot
  // to store the deployment information retrieved
  from KubeSinglePodPrepare String
  deploymentServiceRoutes
  // to construct the response body to update the split definition
  in UPDATE_FEATURE_FLAG stage PodInfo
  podInfo = new PodInfo ( )
}
```

The deployment info sent back from ddp-pipeline's deploy.call can then be stored:

```
import com.xyz.ref.cicd.DefaultStage
import com.xyz.ref.cicd.DeployEnvironment
import java.util.function.Consumer
def call( ) {
    new Consumer<DeployEnvironment>( ) {
      @Override
      void accept(DeployEnvironment deployEnvironment) {
        stage(DefaultStage.DEPLOY_ON_DEMAND.name( ) +
        “${env.DEPLOY_ENVIRONMENT}”)
{
...
        }
      }
    }
}
def deployOnDemand(DeployEnvironment deployEnvironment) {
    def micronConfig = micronConfigHelper.getConfig( )
    def targets =
    deployEnvironment.targetSpecifier.targets(deployEnvironment)
    if (targets != null && !targets.isEmpty( ) ) {
      targets.each { t −>
          try {
              if (t.mode != null) {
                  deployEnvironment.deploymentServiceRoutes=deploy.call(
              ...
                            blueGreenUseAlternateDeploymentSlot:
deployEnvironment. getBlueGreenUseAlternateDeploymentSlot( ),
```

```
  )
  } else {
```

deployEnvironment.deploymentServiceRoutes=deploy.call(

...

```
                              blueGreenUseAlternateDeploymentSlot:
deployEnvironment. getBlueGreenUseAlternateDeploymentSlot( ),
              }
        } catch (IOException ex) {
                  ...
        }
      }
    }
}
import com.xyz.ref.cicd.DefaultStage
import com.xyz.ref.cicd.DeployEnvironment
import java.util.function.Consumer
def call( ) {
    new Consumer<DeployEnvironment>( ) {
      @Override
      void accept(DeployEnvironment deployEnvironment) {
        stage(DefaultStage.RELEASE_ON_DEMAND.name( ) ) {
                  // ... please refer to the repo for the complete code ...
        }
      }
    }
}
/**
  * Executes production secure deployment from ddp-pipeline-cd-secure
  * @param deployEnvironment
  *
  */
def releaseOnDemand(DeployEnvironment deployEnvironment) { def micronConfig
    = micronConfigHelper.getConfig( )
    def targets =
    deployEnvironment.targetSpecifier.targets(deployEnvironment)
    if (targets != null && !targets.isEmpty( ) ) {
      targets.each { t −>
            try {
              if (t.mode != null) {
                      deployEnvironment.deploymentServiceRoutes = deploy.call(
                          ...
                          blueGreenUseAlternateDeploymentSlot:
                          deployEnvironment.
getBlueGreenUseAlternateDeploymentSlot( )
                        )
                } else {
          deployEnvironment.deploymentServiceRoutes = deploy.call(
                            ...
                          blueGreenUseAlternateDeploymentSlot:
                          deployEnvironment.
getBlueGreenUseAlternateDeploymentot( )
                        )
              }
        } catch (IOException ex) {
                  ...
        }
      }
    }
}
```

The additional stages BLUE_GREEN_EVALUATION and UPDATE_FEATURE_FLAG can be added to the pipeline:

```
package com.xyz.ref.cicd
enum DefaultStage
    implements Stage {
    INIT_BUILD,
    BUILD,
    ...
    BLUE_GREEN_EVALUATION,
    UPDATE_FEATURE_FLAG
}
import
com.xyz.ref.cicd.Defa
ultStage import
com.xyz.ref.cicd.Stag
e
void execute(def environmentVars, Stage stage) {
    ...
    switch (stage) {
      case
          DefaultStage.BLUE_GREEN_EVALUATI
          ON:
          stageBlueGreenEvaluation( ) .accep
          t (environmentVars) break
        case
          DefaultStage.UPDATE_FEATURE_FL
          AG:
          stageUpdateFeatureFlag( ) .accep
          t (environmentVars) break
    }
}
feature:
  - INIT_BUILD
deploy:
  - INIT_BUILD
  - COLLECT_APP_METADATA
  - CD_PRE_DEPLOY_POLICY_GATE
  - BLUE_GREEN_EVALUATION
  - DEPLOY_ON_DEMAND
  - PROMOTE_HARMONY_REPORT
  - SWAGGER_UPLOAD
  - FUNCTIONAL_TEST
  - DREDD_CONTRACT_TEST
  - PERFORMANCE_TEST
  - PROVISION_SYNTHETIC_MONITORING
  - UPDATE_FEATURE_FLAG
promote:
  - VALIDATE_DEPLOYMENT
  - INIT_BUILD
```

Then the BLUE_GREEN_EVALUATION stage can be built to update the blueGreenUserAlternateDeploymentSlot:

```
    jnk_pipeline:
      branch:“feature/RRI_2467_ddp_cd_secure_blue_green_sonar”
pipeline:
      execution: deploy_actions:
                        deploy:
                    branches:
                    - “\hat{ }.*rnd.*$”
                    - “\hat{ }.*qa.*$”
                    - “\hat{ }.*uat.*$”
                    action:
                    - “INITIALIZE_CYBERARK_SECRETS”
                    - “BLUE_GREEN_EVALUATION”
                    - “DEPLOY_ON_DEMAND”
                  manifest:
                      post:
                      - “DEPLOYMENT_REGISTRATION”
                      - “UPDATE_FEATURE_FLAG”
              release:
                    branches:
                    - “\hat{ }.*gf1.*$”
                    - “\hat{ }.*gf2.*$”
                action:
                    - “INITIALIZE_PROD_CYBERARK_SECRETS”
                    - “BLUE_GREEN_EVALUATION”
                    - “RELEASE_ON_DEMAND”
                  manifest:
                      post:
                      - “DEPLOYMENT_REGISTRATION”
                      - “UPDATE_FEATURE_FLAG”
    blue_green_evaluation:
      baseUrl: “https://ref-blue-green-outer-ref-rnd.apps.ocp4-
      rnd.xyzint.net/deployment” inactiveEndpoint: “/inactive”
package com.xyz.ref.cicd
class ComponentVersion implements Serializable {
            String name
          String tag
          String type
  }
package com.xyz.ref.cicd
/**
    * Holds information that is related to the blue-green deployment; request
body to update feature flag
    */
class PodInfo implements Serializable {
            String releaseName
            String deploymentName
            String serviceName
            List<String> routeNames
            List<ComponentVersion> componentVersionList
            PodInfo( ) { }
  }
    import com.xyz.ref.cicd.DefaultStage
    import com.xyz.ref.cicd.DeployEnvironment
    import java.util.function.Consumer
    def call( ) {
          new Consumer<DeployEnvironment>( ) { @Override
                  void accept(DeployEnvironment deployEnvironment) {
                      if (env.DEPLOYMENT_STYLE == ‘blue-green’ && env.FEATURE_FLAG_NAME !=
                            null) {
                              stage(DefaultStage.BLUE_GREEN_EVALUATION.name( ) ) {
                                def response = blueGreenHelper.evaluateBlueGreen( )
                                deployEnvironment.setBlueGreenUseAlternateDeploymentSlot(respo
                                nse
    [“alternateDeploymentSlot”] as Boolean)
                            }
                      }
                  }
          }
    }
    import com.xyz.ref.cicd.DefaultStage
    import com.xyz.ref.cicd.DeployEnvironment
    import java.util.function.Consumer
    def call( ) {
          new Consumer<DeployEnvironment>( ) {
                  @Override
                  void accept(DeployEnvironment deployEnvironment) {
                      if (env.DEPLOYMENT_STYLE == ‘blue-green’ && env.FEATURE_FLAG_NAME !=
                            null) { stage (DefaultStage.UPDATE_FEATURE_FLAG.name( ) ) {
                                updateFeatureFlagHelper.updateFeatureFlag(deployEnvironment)
                            }
                      }
                  }
          }
    }
import com.xyz.ref.cicd.DNDException
import com.xyz.ref.cicd.MapUtils
Map evaluateBlueGreen( ) {
        Map micronConfig = micronConfigHelper.getConfig( )
        String featureFlagName = env.FEATURE_FLAG_NAME
        String baseUrl = MapUtils.getOrElse(micronConfig,
  [“blue_green_evaluation”, “baseUrl”], { throw new DNDException(“BaseUrl does
not exist in config.yaml.”) })
        String path = MapUtils.getOrElse(micronConfig, [“blue_green_evaluation”,
“inactiveEndpoint”}, { throw new DNDException(“Blue-green-evaluation endpoint
is not specified in config.yaml.”) })
        String url = “$baseUrl/$featureFlagName/$path”
        Map responseMap = joddHttpClient.get(url, [“Content-Type”:
        “application/json”], [:])
        def responseData = responseMap?.responseBody?.data
        if (!responseData) {
                throw new DNDException( “Failed to fetch unstable version from Split,
please create the Feature Flag before deployment. If the Feature Flag is
created, please check if you had initiated environment.”)
        }
        if (responseData[“alternateDeploymentSlot”] == null) {
                throw new DNDException( “Failed to fetch unstable version from Split.
Please ensure traffic is fully allocated to only one version in Split.”)
        }
        return responseData
}
import com.xyz.ref.cicd.ComponentVersion
import com.xyz.ref.cicd.DNDException
import com.xyz.ref.cicd.DeployEnvironment
import com.xyz.ref.cicd.MapUtils
import groovy.json.JsonOutput
import groovy.json.JsonSlurper
def updateFeatureFlag(DeployEnvironment deployEnvironment) {
        def slurper = new JsonSlurper ( )
        def map = slurper.parseText(deployEnvironment.deploymentServiceRoutes)
        List<ComponentVersion> componentVersionList = buildComponentVersionList ( )
        deployEnvironment.podInfo.setReleaseName(map[“releaseName”] as String)
        deployEnvironment.podInfo.setDeploymentName(map[“deploymentName”] as
        String) deployEnvironment.podInfo.setServiceName(map[“serviceName”] as
        String) deployEnvironment.podInfo.setRouteNames(map[“routeNames”] as
        List<String>)
        deployEnvironment.podInfo.setComponentVersionList(componentVersionList)
        Map micronConfig = micronConfigHelper.getConfig( )
        String featureFlagName = env.FEATURE_FLAG_NAME
        String baseUrl = MapUtils.getOrElse(micronConfig,
  [“blue_green_evaluation”, “baseUrl”], { throw new DNDException(“BaseUrl does
not exist in config.yaml.”) })
        String path = MapUtils.getOrElse(micronConfig, [“blue_green_evaluation”,
  “postChangeEndpoint”}, { throw new DNDException(“Blue-green-evaluation
postChange endpoint is not specified in config.yaml.”) })
        String url = “$baseUrl/$featureFlagName/$path”
        Map responseMap = joddHttpClient.post(url, [“Content-Type”:
  “application/json”], [:], JsonOutput.toJson (deployEnvironment.podInfo) )
        return responseMap
  }
List<ComponentVersion> buildComponentVersionList( ) {
          Map topologyFile = readYaml(file: “topology.yaml”)
          Map versionFile = readYaml(file: “versions.yaml”)
          List topologyList = topologyFile[“topology”]
        def componentVersionList = new ArrayList<ComponentVersion>( );
        for (def topologyItem in topologyList) {
                String componentName = topologyItem[“name”]
                ComponentVersion obj = new ComponentVersion(
                          componentName as String,
                          versionFile[componentName] [“image”] [“tag”] as String,
                          topologyItem[“type”] as String
                )
                componentVersionList.add(obj);
        }
        return componentVersionList
  }
```

The “deploy” in the ddp-pipeline plug-in can be responsible for constructing the required parameters to call the “micronDeploy” defined in ddp-pipeline-cd-secure 720. Once the parameters are built, the “micronDeploy” can be invoked. The “internal_jobs/allow_pipeline_version_param” can be set to “true” in order for the changes made in ddp-pipeline-cd-secure 720 to be detected and utilized. When the deploy method is called in DeployOnDemand stage, the data can be passed in from ref-common-cicd-util/vars/StageDeployOnDemand. A variable, such as “buildResult,” can be used to store the return value from the “build” function. Finally, the extracted downstream environment variables, DEPLOYMENT_SERVICES_AND_ROUTES, can be return for this “call” method.

```
  import groovy.transform.Field
  import xyz.jnk.ArtifactoryHelper
  import xyz.jnk.ManifestHelper
  import groovy.json.JsonOutput
  @Field ArtifactoryHelper helper
  def generateBuildCommandParamsList (Map params, Map config) {
    def buildParams = [ ]
    buildParams.add(
              [
                  $class: ‘StringParameterValue’,
                  name: ‘jsonMap’ ,
                  value: JsonOutput.toJson(params) ,
            ]
    )
    def pipelineVersion = params.get(‘pipelineVersion’, null)
    def allowPipelineVersionParam =
    config.internal_jobs.allow_pipeline_version_param
    if (pipelineVersion && allowPipelineVersionParam) {
          buildParams.add(
                [
                    $class: ‘StringParameterValue’,
                    name: ‘pipelineVersion’,
                    value: pipelineVersion,
                ]
        )
    }
    return buildParams
  }
  def call(Map deployParams = [:]) {
      ...
    deployParams = composeDeployParams(deployParams, manifest,
    manifestGitCoords)
    def parameters = generateBuildCommandParamsList (deployParams, config)
    def buildResult=build job: job, parameters: parameters, wait: true
    return buildResult?.buildVariables?.DEPLOYMENT_SERVICES_AND_ROUTES
  }
...
```

This information can be passed to the ddp-pipeline-cd-secure 720. In order to use the feature branch, allowPipelineVersionParam can be set to true

internal_jobs:
allow_pipeline_version_param: true

Within the ddp-pipeline-cd-secure 720, the “micronDeploy” can be used to construct an argument list that includes the “blueGreenUseAlternateDeploymentSlot” parameter. This argument list can then be passed into a shell script called “steps.sh” residing in an artifactory. A new argument, blueGreenUseAlternateDeploymentSlot, can be added when executing the steps.sh. The return value from steps.sh can be stored as, for example, fullOutput, and it can be parsed with the parseDeploymentServiceRoutes.sh. Finally, the parsed value can be stored in the environment variable, DEPLOYMENT_SERVICES_AND_ROUTES. This environment variable can pass data upstream to be used in a later stage of the pipeline.

```
def call(Map deployParams = [:]) {
  ...
  def blueGreenUseAlternateDeploymentSlot=
  deployParams.get(‘blueGreenUseAlternateDeploymentSlot’, false)
  for (pair in manifest.manifest.components) {
    ...
    withCredentials([string(credentialsId:
    targetOCPClusterConfig?.credentialsId, variable: ‘token’)]) {
      ...
      String args = [
            “${branchName}”,
            “${version}”,
            “${dockerTag}”,
            “${cluster}”,
            “${namespace}”
            “${projectName}”,
            “${mode}”,
            “${deploymentType}”,
            “${blueGreenUseAlternateDeploymentSlot}”
      ].join(‘ ’)
      docker.image(config.docker.builder_images.micron).inside( ) {
          ...
        dir(projectPath) {
            def fullOutput = sh(returnStdout: true, script: “set +x &&
            ${envVars} /app/steps.sh
${args}”)?.trim( )
            def lines = fullOutput?.split(‘\n’)
            def capturedOutput = ‘’
            for (String line : lines) {
              if(line.startsWith(‘DEPLOYMENT_SERVICE_ROUTES_FROM_KUBE_SIN
              GLE_POD_PREPARE: ’)){
                capturedOutput = line -
                ‘DEPLOYMENT_SERVICE_ROUTES_FROM_KUBE_SINGLE_POD_PREPARE:
’
                break
              }
            }
            env.DEPLOYMENT_SERVICES_AND_ROUTES= capturedOutput
      }
      }
    }
  }
}
```

The shell script can reside in a docker image that was created from ddp-cd-micron-deployer.

```
docker:
  repo: ‘docker-stage.docker.xyzint.net’
  credentialsId: JenkinsServiceID-PROD
  builder_images:
    micron: ‘xyz/ddp/cd-micron-deployer:1.1.28-1691697633315’
```

In various embodiments, within the shell script “step.sh”, if the “blueGreenUseAlternateDeploymentSlot” parameter is true during the single pod deployment, it will be included in the gradle command that invokes “kubeSinglePodPrepare”. To publish this updated shell script on the artifactory, certain environment variables in the Jenkinsfile, namely PRIMARY_BRANCH, DOCKER_TAG, and version, need to be updated. The version should be incremented, and PRIMARY_BRANCH should be set to the feature branch. Once the changes in the feature branch are pushed to Bitbucket, the artifact will be generated, containing the new version of the shell script. The shell script that is executed in ddp-pipeline-cd-secure/vars/micronDeploy

The new feature branch can be specified and the version in DOCKER_TAG and version can be incremented to generate a new artifact based on the changes made in the feature branch.

```
  library ‘pipeline’
  pipeline {
    agent {
            kubernetes {
          inheritFrom ‘tools-base’
        }
    }
    options {
      timeout(time: 2, unit: ‘HOURS’)
      buildDiscarder(logRotator(numToKeepStr: ‘20’))
    }
    environment {
        MNEMONIC = ‘DDP’
      PRIMARY_BRANCH = ‘feature/ddp-cd-micron-deployer-blue-green’
      GROUP = ‘xyz.ddp’
      ARTIFACT = ‘cd-micron-deployer’
      DOCKER_TAG = “1.1.28-${currentBuild.getStartTimeInMillis( )}”
      DOCKER_REPO = ‘docker-stage.docker.xyzint.net’
      imageName = ‘cd-micron-deployer’
      version = ‘1.1.28’
    }
    stages { stage(‘Initialization’) {
          steps {
                initialization( )
          }
        }
      stage (‘Build Image’) {
            steps {
              buildImage( )
          }
        }
    }
    post {
      always {
      generalCleanup( )
      }
    }
}
```

During the execution of kubeSinglePodPrepare, the “blueGreenUserAlternateDeploymentSlot” can be provided as an argument in the gradle command. There can be two locations where it is needed to substitute the project.name with the new release name. The first one is within the generateValues method, while the other is within the generateHelmTemplates method. In the generate Values method, the blueGreenUseAlternateDeploymentSlot is passed as a parameter and utilized within ValuesMapperUtil.mapPodProperties. Within the mapPodProperties method, the deployment name remain the same as project.name if blueGreenUserAlternateDeploymentSlot is false; otherwise, deployment name will be modified with a subfix, “-b”. Similarly, in generateHelmTemplates, the release name, which can be employed for naming the service, is substituted with project.name+“-b” if blueGreenUseAlternateDeploymentSlot is true; if blueGreenUseAlternateDeploymentSlot is false, the release name remains project.name. When the kubeSinglePodPrepare is called when executing the shell script, the blueGreenUserAlternateDeploymentSlot attribute can be added to kubeSinglePodPrepare from the shell script.

```
package com.xyz.micron.deploy.plugin.gradle.util
interface Literals {
  ...
  interface TaskArgumentParameterLiterals {
  ...
  String ARG_BLUE_GREEN_USE_ALTERNATE_DEPLOYMENT_SLOT =
“blueGreenUseAlternateDeploymentSlot”
    String DESC_BLUE_GREEN_USE_ALTERNATE_DEPLOYMENT_SLOT = “Flag to
indicate that the blue green deployment should use the alternate (-b)
deployment slot”
  }
}
```

A model can be built to store the resulting deployment information, including releaseName, deploymentName, serviceName, and routeNames:

```
package com.pnc.micron.deploy.plugin.gradle.model.value
import com.fasterxml.jackson.databind.ObjectMapper
/ **
  * An object representing information related to the deployment. For blue-
green deployment
  **/
class DeploymentInfo {
    String releaseName
    String deploymentName
    String serviceName
    List<String> routeNames
    DeploymentInfo(def releaseName, def deploymentName, def serviceName, def
routeNames) {
      this.releaseName = releaseName
      this.deploymentName = deploymentName
      this.serviceName = serviceName
      this.routeNames = routeNames
      }
      static String toJsonString(def deploymentInfo) {
        (new ObjectMapper( )).writeValueAsString(deploymentInfo)
      }
}
```

Some constants can be added to be used in gathering the deployment information.

```
package com.xyz.micron.deploy.plugin.gradle.util
interface Constants {
  ...
  def FILE_DEPLOYMENT = “deployment.yaml”
  def FILE_SERVICE = “service.yaml”
  def FILE_ROUTES = “route.yaml”
}
```

To gather deployment information, pseudo code such as the following can be used.

```
package com.xyz.micron.deploy.plugin.gradle.util
import com.xyz.micron.deploy.plugin.gradle.model.value.DeploymentInfo
import org.slf4j.LoggerFactory
import org.yaml.snakeyaml.Yaml
class DeploymentInfoReader {
  static def logger =
LoggerFactory.getLogger (DeploymentInfoReader.class)
  static def readDeployment Info (def path) {
    def deploymentConf = readDeploymentFile(path)
    logger.warn(“deployment: { }”, deploymentConf)
    return new DeploymentInfo (
      deployment Conf.releaseName,
      deployment Conf.deploymentName,
      readServiceName (path) ,
      readRoutes (path)
    )
}
  private static def readDeploymentFile (def path) {
    def item = readYaml(path.resolve(Constants.FILE_DEPLOYMENT))[0]
    return [
      “releaseName” : item?.metadata?.labels?.release,
      “deploymentName”: item?.metadata?.name
    ]
  }
  private static def readServiceName (def path) {
    def items = readYaml (path.resolve(Constants.FILE_SERVICE))
    return items[0]?.metadata?.name
    }
  private static def readRoutes (def path) {
    def items = readYaml (path.resolve(Constants.FILE_ROUTES))
    return items.collect { i −> i?.metadata?.name }
      .findAll { i −> i != null}
  }
  private static def readYaml (def filePath) {
    def items = new Yaml( ).loadAll(new FileInputStream (new
File(filePath.toString( ))))
    return items
  }
}
```

In various embodiments, generate Values can call ValuesMapperUtil.mapPodProperties to generate the values.yaml. The deployment name, in Val, uesMapperUtil.mapPodProperties. The releaseName in the helm template can govern the service name of the deployment, so that project.name should be replaced with new releaseName if the blueGreenUseAlternateDeploymentSlot is true.

```
package com.xyz.micron.deploy.plugin.gradle.task.kube
...
class KubeSinglePodPrepareTask extends BaseMicronTask {
  ...
  private static def ALTERNATE_DEPLOYMENT_SUFFIX = “-b”
  @Option(option =
Literals.TaskArgument ParameterLiterals.ARG_BLUE_GREEN_USE_ALTERNATE_DEPLOYMEN
T_SLOT,
    description = Literals.TaskArgument ParameterLiterals.
DESC_BLUE_GREEN_USE_ALTERNATE_DEPLOYMENT_SLOT)
  @Input
  @Optional
  Boolean blueGreenUseAlternateDeploymentSlot
  @TaskAction
  void action( ) {
    ...
      def releaseName = blueGreenUseAlternateDeploymentSlot ?
“$project.
name$ALTERNATE_DEPLOYMENT_SUFFIX” : project.name
      logger.warn(“release name: { }”, releaseName)
      rootPlatformConfig.platformConfig.each { key, config −>
        generateValues(key, config, platformConfigMap, version,
topology, releaseName)
      ...
      generateHelmTemplates(project, chart, releaseName, key.namespace,
destinationDir, valuesPath)
    }
    def platform =
rootPlatformConfig.platformConfig.entrySet( ).first( ).key
    def pathToHelmTemplates =
PathUtil.getDirGradleBuildDeployKube(project)
      .resolve(platform.cluster)
      .resolve(platform.namespace)
      .resolve(chart.toString( ))
      .resolve(“templates”)
    Logger.lifecyle
(“DEPLOYMENT_SERVICE_ROUTES_FROM_KUBE_SINGLE_POD_PREPARE:{ }”, DeploymentInfo.
toJsonString(
      DeploymentInfoReader.readDeploymentInfo(pathToHelmTemplates)))
}
  def generateValues(def key, def config, def platformConfigMap, def
version, def topology, def releaseName) {
  ...
    values = ValuesMapperUtil.mapPodProperties(values, project, config,
releaseName)
    ...
  }
  def generateHelmTemplates(def project, def chart, def name, def
namespace, def destinationDir, def valuesPath) {
    logger.lifecycle(“Generating deployment files”)
    return HelmUtil.template(project, chart, name, namespace,
destinationDir, valuesPath as Path[ ])
  }
}
```

In various embodiments, if blueGreenUseAlternateDeploymentSlot is true, the releaseName will be project.name with appending suffix, “-b”; otherwise, the releaseName is project.name.

```
class ValuesMapperUtil {
  ...
  static mapPodProperties(def values, def project, def config, def
  releaseName) {
      values[“deployment”] = [
        “name” : releaseName,
        “replicas” : config.deployment.replicaCount,
        “rollingUpdates” : config.deployment.rollingUpdate ? [
          “maxSurge” : config.deployment.rollingUpdate.maxSurge,
          “maxUnavailable”:config.deployment.rollingUpdate.maxUnavailabl
          e,
        ] : null,
        “serviceAccount” : config.deployment.serviceAccount ?: “null”,
        “serviceAccountName” : config.deployment.serviceAccountName ?: “null”,
      ]
    ...
}
```

The HelmUtil.template can be made to return the full path of the resulting deployment related files, such as deployment.yaml, in various embodiments.

```
static String template(Project project, String chart, String releaseName,
String releaseNamespace, Path destinationPath, Path... pathsToValueFiles) {
    def pathsToValueFilesString = pathsToValueFiles.toList( )
      .stream( )
      .map({ path −> path.toAbsolutePath( ) })
      .map({ absolutePath −> absolutePath.toString( ) })
      .collect(Collectors.joining(“,”))
  return CmdUtil.executeAndStream(
    getBuildMicronHelmPath(project),
    “template”,
    PathUtil.getDirGradleBuildMicron (project).resolve(chart).toString( ),
    “--output-dir”, destinationPath.toAbsolutePath( ).toString( ),
    “--values”, pathsToValueFilesString, “-- name”, releaseName,
    “--namespace”, releaseNamespace
  )
}
```

The software for the various computer systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and ×86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

In one general aspect, therefore, the present invention is directed to computer-based systems and methods for controlling network traffic allocation to different versions of a software application for a service. The computer-based system can comprise a first version of the software application running on a first network resource of the computer-based system and a second version of the software application running on a second network resource of the computer-based system, where the second version is different from the second version. The system also comprises a load balancer in communication with the first and second network resources and a toggle interface for receiving user input indicative of a desired network traffic allocation between the first and second versions of the software application. The computer-based system further comprises a version control service for: periodically polling the toggle interface for an updated network traffic allocation between the first and second versions of the software application, where the updated network traffic allocation is based on the user input received by the toggle interface; and communicating the updated network traffic allocation between the first and second versions of the software application to the load balancer. The load balancer is for allocating network traffic for the software application to the first and second versions of the software application in accordance with the updated network traffic allocation.

The method, according to various embodiments, comprises the steps of storing a first version of the software application running on a first network resource of the enterprise network and storing a second version of the software application running on a second network resource of the enterprise network, wherein the second version is different from the second version. The method also comprises the step of receiving, by a toggle interface, user input indicative of a desired network traffic allocation between the first and second versions of the software application. The method further comprises the step of periodically polling, by a version control service, the toggle interface for an updated network traffic allocation between the first and second versions of the software application, where the updated network traffic allocation is based on the user input received by the toggle interface. The method further comprises the step of communicating, by the version control service, the updated network traffic allocation between the first and second versions of the software application to a load balancer that is in communication with the first and second network resources, And the method further comprises the step of allocating, by the load balancer, network traffic for the software application to the first and second versions of the software application in accordance with the updated network traffic allocation.

In various implementations, the toggle interface stores feature flags related to the updated network traffic allocation between the first and second versions of the software application that is based on the user input received by the toggle interface. Also, the toggle interface can comprise a web-based interface for receiving the user input. Still further, the toggle interface can employ a Boolean attribute that has a first value when only one of the first and second versions of the software application is available for deployment, and has a second value when both of the first and second versions of the software application are available for deployment.

In various implementations, the second version has a different name than the first version. For example, the different name of the second version can comprise a name of the first version plus a suffix.

In various implementations, the first network resource comprises a first endpoint of a network comprising the load balancer; and the second network resource comprises a second endpoint of the network. In that connection, the first network resource can comprise a first pod in the network and the second network resource comprises a second pod in the network. In various implementations, the first pod comprises a first collection of one or more containers and the second pod comprises a second collection of one or more containers.

In various implementations, the second version of the software application is developed after the first version of the software application. For example, the second version fixes at least one bug in the first version.

In various implementations, the network traffic comprises HTTP requests for the service.

In various implementations, the version control service is for communicating the updated network traffic allocation between the first and second versions of the software application to the load balancer via an API.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A computer-based system for controlling network traffic allocation to different versions of a software application for a service, the computer-based system comprising:
a first version of the software application running on a first network resource of the computer-based system;
a second version of the software application running on a second network resource of the computer-based system, wherein the second version is different from the second version;
a load balancer in communication with the first and second network resources;
a toggle interface for receiving user input indicative of a desired network traffic allocation between the first and second versions of the software application;
a version control service for:
periodically polling the toggle interface for an updated network traffic allocation between the first and second versions of the software application, wherein the updated network traffic allocation is based on the user input received by the toggle interface; and
communicating the updated network traffic allocation between the first and second versions of the software application to the load balancer,
wherein the load balancer is for allocating network traffic for the software application to the first and second versions of the software application in accordance with the updated network traffic allocation.

2. The computer-based system of claim 1, wherein the toggle interface stores feature flags related to the updated network traffic allocation between the first and second versions of the software application that is based on the user input received by the toggle interface.

3. The computer-based system of claim 2, wherein the toggle interface comprises a web-based interface for receiving the user input.

4. The computer-based system of claim 2, wherein the toggle interface employs a Boolean attribute that has a first value when only one of the first and second versions of the software application is available for deployment, and has a second value when both of the first and second versions of the software application are available for deployment.

5. The computer-based system of claim 1, wherein the second version has a different name than the first version.

6. The computer-based system of claim 5, wherein the different name of the second version comprises a name of the first version plus a suffix.

7. The computer-based system of claim 1, wherein:
the first network resource comprises a first endpoint of a network comprising the load balancer; and
the second network resource comprises a second endpoint of the network.

8. The computer-based system of claim 7, wherein the first network resource comprises a first pod in the network and the second network resource comprises a second pod in the network.

9. The computer-based system of claim 8, wherein the first pod comprises a first collection of one or more containers and the second pod comprises a second collection of one or more containers.

10. The computer-based system of claim 1, wherein the second version of the software application is developed after the first version of the software application.

11. The computer-based system of claim 10, wherein the second version fixes at least one bug in the first version.

12. The computer-based system of claim 1, wherein the network traffic comprises HTTP requests for the service.

13. The computer-based system of claim 1, wherein the version control service is for communicating the updated network traffic allocation between the first and second versions of the software application to the load balancer via an API.

14. A computer-based system for controlling network traffic allocation to different versions of a software application for a service, the computer-based system comprising:
a first version of the software application running on a first network resource of the computer-based system;
a second version of the software application running on a second network resource of the computer-based system, wherein the second version is different from the second version;
a load balancer in communication with the first and second network resources;
a toggle interface for receiving user input indicative of a desired network traffic allocation between the first and second versions of the software application;
a version control service comprising
means for periodically polling the toggle interface for an updated network traffic allocation between the first and second versions of the software application, wherein the updated network traffic allocation is based on the user input received by the toggle interface; and
means for communicating the updated network traffic allocation between the first and second versions of the software application to the load balancer,
wherein the load balancer is for allocating network traffic for the software application to the first and second versions of the software application in accordance with the updated network traffic allocation.

15. A computer-based method for controlling network traffic allocation to different versions of a software application for a service of an enterprise network, the computer-based method comprising:
storing a first version of the software application running on a first network resource of the enterprise network;
storing a second version of the software application running on a second network resource of the enterprise network, wherein the second version is different from the second version;
receiving, by a toggle interface, user input indicative of a desired network traffic allocation between the first and second versions of the software application;
periodically polling, by a version control service, the toggle interface for an updated network traffic allocation between the first and second versions of the software application, wherein the updated network traffic allocation is based on the user input received by the toggle interface;
communicating, by the version control service, the updated network traffic allocation between the first and second versions of the software application to a load balancer that is in communication with the first and second network resources; and
allocating, by the load balancer, network traffic for the software application to the first and second versions of the software application in accordance with the updated network traffic allocation.

16. The computer-based method of claim 15, wherein:
the toggle interface stores feature flags related to the updated network traffic allocation between the first and second versions of the software application that is based on the user input received by the toggle interface; and
the toggle interface comprises a web-based interface for receiving the user input.

17. The computer-based method of claim 16, wherein the toggle interface employs a Boolean attribute that has a first value when only one of the first and second versions of the software application is available for deployment, and has a second value when both of the first and second versions of the software application are available for deployment.

18. The computer-based method of claim 17, wherein:
the second version has a different name than the first version; and
the different name of the second version comprises a name of the first version plus a suffix.

19. The computer-based method of claim 18, wherein:
the first network resource comprises a first endpoint of the enterprise network; and
the second network resource comprises a second endpoint of the enterprise network.

20. The computer-based method of claim 19, wherein:
the first network resource comprises a first pod in the enterprise network and the second network resource comprises a second pod in the enterprise network;
the network traffic comprises HTTP requests for the service; and
the version control service is for communicating the updated network traffic allocation between the first and second versions of the software application to the load balancer via an API.

21. The computer-based method of claim 20, wherein the second version fixes at least one bug in the first version.
